(19) United States
(12) Patent Application Publication
(10) Pub. No.: US 2014/0336295 A1
(43) Pub. Date: Nov. 13, 2014

(54) POROUS BODY USEFUL AS A FILTER ELEMENT

(71) Applicant: E I DU PONT DE NEMOURS AND COMPANY, Wilmington, DE (US)

(72) Inventors: CHANGZAI CHI, Hockessin, DE (US); JEFFREY SCOTT METH, Landenberg, PA (US)

(73) Assignee: E I DU PONT DE NEMOURS AND COMPANY, Wilmington, DE (US)

(21) Appl. No.: 13/890,318

(22) Filed: May 9, 2013

(51) Int. Cl. B01D 39/20

(52) U.S. Cl. CPC B01D 39/2079; B82Y 30/00
USPC 521/149; 210/510.1; 210/767; 210/496; 210/490; 210/435; 55/523; 55/495; 95/273; 521/189; 977/781; 977/900; 977/902

(57) ABSTRACT

A porous body consists essentially of a plurality of ceramic particles having an average size ranging from 8 to 100 nm. The ceramic particles are bonded to adjacent ceramic particles with a strength sufficient to render the porous body self-supporting. The porosity ranges from 30 to 70 vol. % and the average pore size ranges from 5 to 50 nm. The porous body may be manufactured by preparing a dispersion comprising the ceramic particles and a polymer matrix material in a solvent, removing the solvent by heating and/or evaporation, forming a preform of the dried material, and firing the preform to remove the polymer matrix material and bond the ceramic particles to each other. The porous body is useful as a filter element in a system adapted to remove nanoscale particles from a fluid stream.

### TECHNICAL FIELD

The subject matter hereof relates to a porous body having nanoscale features that render it capable of filtering a fluid medium to remove therefrom particles having characteristic sizes that may be as low as about 10 nm, and to the manufacture of such a porous body and its use in a filtration system.

### BACKGROUND

The need to filter a fluid medium, either liquid or gaseous, to remove particles contained therein arises in a wide range of fields, and for particles ranging in size from macroscopic particles of 1 mm or more down to viruses that may be as small as about 20 nm. Techniques able to isolate proteins and similar biomolecules as small as 1 nm are also sought.

For centuries, various forms of a single-layered, mesh- or screen-like structure have been used to perform filtering operations. These operations rely on apertures in the structure that have a size that physically blocks passage of particles or other objects larger than the aperture size. Each aperture opens to opposite sides of the single-layered structure and affords a single, straight path for through passage of the fluid and particles smaller than the aperture size. For relatively large particles, a suitable screen can readily be formed by weaving appropriately-sized wires in a generally perpendicular arrangement, thereby creating apertures that are approximately square. Such structures are familiar in many domestic and industrial applications. A mesh-like filter structure can also be formed using so-called perforated or expanded metal. However, it becomes increasingly difficult to form filter elements by any of these techniques as the desired aperture size (sometimes termed mesh size) decreases, especially for sizes smaller than those directly perceptible by the unaided human eye.

An alternative approach is termed “depth filtering.” Unlike the foregoing single-layer structures, elements for depth filtering provide a random network of pore channels through which a particle-containing fluid passes. Generally, such a structure comprises pores that vary in size and geometry. The passages through the structure are predominantly circuitous and not straight-line. Compared to a single-layer filter like a screen or mesh, a depth filter can often remove a higher amount of particulate material before becoming clogged, given the larger number of pathways and larger surface area in the pores.

An exemplary depth-filtering configuration has long been employed for filtering water, by causing it to pass through a bed of particles of sand or the like. In this case, the filtering medium is not self-supporting, and must be contained by an ancillary structure. In addition, the range of particle size that can be filtered in this manner is determined by the particle size distribution of the filtering medium

Depth filtering may also be done with structures that comprise randomly-distributed or woven fibers of natural or synthetic materials, including cellulose, polymers, glass, or the like. In some cases, such structures are self-supporting. Cellulose-based paper filters are familiarly used, e.g. in domestic applications such as brewing coffee or other beverages, and in industrial contexts, such as chemical laboratories. Similarly constructed filter media structures, either woven or unwoven (e.g. felted) are used to filter oil and like fluids that circulate in internal combustion engines and in industrial equipment such as compressors. Air or other exhaust gases from industrial processes are commonly filtered using by woven or non-woven sheets as the filter medium, sometimes in the context of a filtering system known as a baghouse. In this approach, the filter medium often is configured as a bag open at one end and closed at the other end. Ordinarily, depth filtering is useful for filtering of particles as small as about 1 μm.

Current technology for filtering below 1 μm particle size typically relies on membrane filter media, which ordinarily are another form of a sheet-like filter having microscale apertures that trap the desired particles. Membrane filters include ones made by controlled precipitation of polymers of various types from a solvent. Other membrane filters are made by exposing a thin polymer (e.g. polycarbonate or polyethylene) to ionizing radiation to create tracks of radiation-damaged material extending through the polymer, then chemically eroding the degraded material to create full penetrations. Still others (e.g., Gore® Microfiltration Media) are made by carefully stretching sheet-form polymers such as PTFE. One representative application of membrane filters is the removal of bacteria from water to render it safely potable.

A key measure of performance of a filtration system in virtually all applications is the ability to sustain filtration capability for capturing the desired particles over an extended operating time. This requires that an acceptably high flow rate be maintained without excessive backpressure. The passage of a fluid through any filter element necessarily results in a difference in pressure (termed “backpressure”) between the input and output sides of filter, because the flow is restricted. More specifically, in the course of operation, a filter medium traps particles, restricting or even blocking the initially-available flow paths. As blockage occurs, the backpressure across the filter element for a given throughput necessarily and undesirably increases. The filter element and/or the filter medium thereof must then either be cleaned or replaced.

While in some applications it is sufficient if a preselected fraction of small particles is removed, in others, it is desirable, or even critical, that all particles smaller than a predetermined characteristic size be removed, Especially stringent demands are often encountered in medical and biological filtering applications, in which removal of pathogens (e.g., bacteria and viruses) from fluids by some means is necessary. Typical sizes for these agents are about 300 nm to 10 μm and about 20 nm to 200 nm, respectively. In some instances, it is also desirable to remove certain protein molecules having sizes as small as 1 nm.

For example, it may be desirable or required that pharmaceutical or other therapeutic fluids to be injected into humans or animals be filtered to ensure that there are no transmittable viruses present, such as the AIDS or hepatitis-C viruses. The requirement may be as stringent as demanding that less than one virus molecule be present in a million therapeutic doses. At present, suitably configured membrane filters are the best available means for trapping and filtering these particles to such levels, especially at the lower sizes. However, the throughput of membrane filters is inherently limited. The areal density of apertures actually present is small, so the back pressure for an acceptable flow rate is necessarily high, even for a pristine filter element. In addition, membrane filter media are easily clogged, since an aperture becomes plugged once it has trapped a particle. To maintain sterility, the membrane filter ordinarily must be replaced after each use, usually at high cost.

Many current filter media are also limited by their relatively wide distribution of pore sizes. The average pore size typically is kept as large as possible to reduce back pressure and increase flow rates. However, to improve the probability that the smallest particles will be captured by a filter medium that has a wide distribution of pore sizes, the flow distance must be increased, ordinarily increasing back pressure. Ideally, a filter also has a high density of passages (pores and/or apertures), consistent with required mechanical characteristics, such as being self-supporting. A high density ordinarily reduces backpressure, increases throughput, and reduces the rate at which performance is degraded by clogging.

Thus, there remains a need for an inexpensive filter element that is capable of removing nanometer-sized particles, while maintaining high throughput at low backpressure for an extended time.

### SUMMARY

An aspect of the present invention provides, as an article of manufacture, a porous body having an outer surface that defines a shape having a bulk volume, the porous body consisting essentially of a plurality of ceramic particles having an average size ranging from 8 to 100 nm, and wherein:
a) the ceramic particles are bonded to adjacent ceramic particles with a strength sufficient to render the porous body self-supporting;
b) the porous body has a porosity ranging from 30 to 70 vol. %; and
c) the porous body has an average pore size ranging from about 5 to 50 nm.

Such a porous body finds multiple uses, including as the medium in a filtration system.

In a related aspect, there is provided, as an article of manufacture, a supported porous body comprising a substrate and a monolithic, porous layer supportedly bonded thereto, the porous layer consisting essentially of a plurality of ceramic particles having an average size ranging from 8 to 100 nm, and wherein:
a) the ceramic particles are bonded to adjacent ceramic particles with a strength sufficient to provide the supported porous body with structural integrity;
b) the porous layer has a porosity ranging from 30 to 70 vol. %; and
c) the porous layer has an average pore size ranging from about 5 to 50 nm.

Another aspect provides a method for manufacturing a porous body having an outer surface that defines a shape having a bulk volume, comprising:
a) producing a polymeric nanocomposite comprising a plurality of ceramic particles having an average size ranging from 8 to 100 nm dispersed in a polymeric matrix material, the ceramic particles comprising 30 to 70% of the bulk volume of the polymeric nanocomposite; and
b) firing the polymeric nanocomposite at a firing temperature and for a firing time sufficient to remove substantially all the polymeric matrix material and to cause the ceramic particles to become bonded to adjacent ceramic particles with a strength sufficient to render the porous body self-supporting.

Still another aspect provides a method for filtering a fluid containing particulate material to produce a filtrate, comprising:

(a) providing a filter element comprising a porous body having an outer surface that defines a shape having a bulk volume, consisting essentially of a plurality of ceramic particles having an average size ranging from 8 to 100 nm, and wherein:
(i) the ceramic particles are bonded to adjacent ceramic particles with a strength sufficient to render the porous body self-supporting;
(ii) the porous body has a porosity ranging from 30 to 70 vol. %; and
(iii) the porous body has an average pore size ranging from about 5 to 50 nm; and

(b) passing the fluid through the porous body, whereby the fluid is filtered to remove at least a portion of the particulate material to produce the filtrate.

Yet another aspect provides a filtration system configured to filter a fluid containing particulate material to produce a filtrate, and comprising a filter element having an input and an output, and wherein:

(a) the filter element comprises a porous body having an outer surface that defines a shape having a bulk volume, consisting essentially of a plurality of ceramic particles having an average size ranging from 8 to 100 nm, and wherein:
(i) the ceramic particles are bonded to adjacent ceramic particles with a strength sufficient to render the porous body self-supporting;
(ii) the porous body has a porosity ranging from 30 to 70 vol. %; and
(iii) the porous body has an average pore size ranging from about 5 to 50 nm; and

(b) the input is in fluidic communication with the porous body, such that fluid received at the input is delivered to the porous body for passage therethrough to produce filtrate; and

(c) the output is in fluidic communication with the porous body, such that filtrate emerging from the porous body is delivered to the output.

### BRIEF DESCRIPTION OF THE DRAWINGS

The invention will be more fully understood and further advantages will become apparent when reference is had to the following detailed description of the preferred embodiments of the invention and the accompanying drawing, in which:

FIGS. 1 to 3 are graphs depicting the pore volume distribution of various porous bodies of the present disclosure.

### DETAILED DESCRIPTION

Several patents, patent applications, and publications are cited in this description in order to more fully describe the present invention. The entire disclosure of each of these patents, patent applications and publications is incorporated by reference herein.

Unless otherwise defined, all technical and scientific terms used in the present specification and subjoined claims have the same meaning as commonly understood by one of ordinary skill in the art to which this invention belongs. In case of conflict, this specification, including definitions set forth herein, will control.

It should be understood that in some instances herein, polymers may be described by referring to the monomers or the amounts thereof used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof.

In one aspect of the present disclosure, a nanoporous ceramic structure is prepared from a polymeric nanocomposite preform, which comprises suitable ceramic particles dispersed in a polymer matrix at relatively high loading. This nanocomposite preform can be prepared by any suitable technique, including compression molding, to form a bulk object that may have any desired overall shape. In representative embodiments, the bulk object is formed as a plate, disk, cylindrical shell, or the like, although other shapes are also possible. The nanocomposite preform is heated to remove the polymer, e.g., by pyrolysis, volatilization, or the like, leaving behind a skeletal structure of the ceramic material characterized by relatively well-defined and uniform pores.

An ideal porous body would have a high degree of porosity, as specified by the volume percentage (vol. %) of pores within the bulk object. Increasing the porosity ordinarily enhances the ability of a body used in filtration to pass fluid as rapidly as possible. Various embodiments of the present porous body may have a porosity of about 30 to 70%, or a porosity of at least about 30 vol. %, 50 vol. %, 60 vol. %, 70 vol. %, or 75 vol. %. In an embodiment, the porosity of the present porous body is as high as possible, consistent with the requirement that the interparticle bonding be sufficient to produce a monolithic skeletal structure.

An ideal porous body for filtration further has a narrow distribution of the size of its pores, so that a well-defined characteristic particle filtration size is attained. Passing a fluid through an ideal filtration element would completely remove all spherical particles larger than the element's characteristic particle filtration size, while passing all smaller particles. However, a practical filtration element will pass substantially all large particles and trap substantially all small particles, but trap only a portion of particles in an intermediate size range. For an ideal element, the intermediate size range is thus negligibly narrow, but filtration elements with a distribution of pore sizes or a distribution of through aperture sizes will necessarily have some finite intermediate size range. The term “characteristic particle filtration size” is thus used herein to specify the size of a spherical particle in a fluid that would have a 50% probability of being trapped upon passage through a given filtration element. The characteristic particle filtration size thus is typically related to the average pore or aperture size of a given element. Many filtration systems would benefit from having the selectivity arising from use of a filtration element that has a well-defined characteristic particle filtration size and a narrow intermediate size range.

In an embodiment, the present porous body may have a pore size distribution wherein at least 80% of the pore volume is contained in pores having a pore size within a range of about 5 to 50 nm, about 10 to 20 nm, or a relatively narrow range of about 4 to 9 nm, or about 12 to 16 nm. In an embodiment of the present porous body, the size distribution of the pores is largely governed by factors that include the particle size of the initial ceramic starting material. Embodiments of the present porous body also includes ones in which the pore size distribution is such that the pore size ranges from 5 to 50 nm, about 10 to 20 nm, about 4 to 9 nm, or about 12 to 16 nm, as measured either by the arithmetic average or mode.

The configuration of the present bulk object and its pore structure render it permeable to passage of fluid though it and capable of functioning as a filtration element. Fluid passing through the porous structure is filtered to form a filtrate, by removal of at least a portion, or substantially all, of any particles larger than a given characteristic size. The pore structure provides a multiplicity of flow channels through which fluid may pass for filtration.

A wide variety of ceramic particles and polymer matrix materials are usefully employed in the fabrication of the preform, provided that: (a) the ceramic particles can be well dispersed in the polymer, (b) the polymer can be removed by heating in a firing operation, and (c) sufficient interbonding of the ceramic particles is attained during the firing operation to render the skeleton monolithic and self-supporting. By monolithic is meant that the finished body has a structural integrity that is provided by the interbonding of the ceramic particles provided in the unfired preform to adjacent particles; by “self-supporting” is meant that the finished body does not appreciably conform, by virtue of its own weight, to the shape of any structure on which it is placed and that it can be manipulated without any appreciable deformation, fracture, or other degradation.

In an embodiment, the preform is fabricated by first preparing a formulation wherein polymer and ceramic particles are distributed in a suitable solvent, such as water or a polar organic liquid. The constituents do not necessarily form a true solution in the solvent. Rather, it is sufficient that the distribution of the polymer and ceramic particles in the solvent be spatially homogeneous. In some embodiments, removal of the solvent results in a dried powder which can then be processed to form a green compact by compression molding or other suitable technique. Alternatively, removal of the liquid produces a green compact directly.

The green compact is then fired to remove the polymer and any residual solvent and create the present porous body. In an embodiment, the firing operation is carried out at a temperature and for a time sufficient to attain substantially full removal of the polymer matrix, but well below the conditions at which sintering of the ceramic particles occurs. In an embodiment, the heating is carried out at a peak temperature of 100° C. to 1000° C., or 200° C. to 850° C., or 250° C. to 800° C., as appropriate for the particular ceramic particles and polymer matrix used. In an embodiment the firing conditions are selected so that no appreciable sintering of the ceramic particles occurs, the porosity of the fired porous body structure largely reflects the original volume packing of the ceramic particles in the green compact, and substantially no necking is induced by the firing at points of the original particles' tangencies.

It will be appreciated that the relative volumetric concentration of the polymer and the ceramic particles in the initial formulation determines the relative concentration in the green compact, and thus substantially governs porosity of the final body after the firing. In general, the ultimate porosity is approximately equal to the volume fraction of polymer in the green compact.

Surprisingly, the skeleton that results from the firing is self-supporting and sufficiently robust for simple manipulations. In some embodiments, the porous body has sufficient integrity that it may be deployed in a filtration system using only a minimal holder or like support structure. Ideally, the holder needs only to position and externally constrain the element, and no additional mechanical support is needed. Ordinarily, the filter element is configured such that at least some, and generally all, of the input fluid passes through the porous body for filtration. However, the filter element may also be configured to provide some degree of bypass either under all conditions or if the back pressure is excessive, e.g. as the result of a clogged filtration medium. In some embodiments of the present filtration system, the filter element and its porous body are situated in a modular, cartridge-type arrangement that can be fluidically connected to the rest of the system, rendering it easy to service or replace as needed.

Ceramic particles suitably employed in constructing the present element include, without limitation, oxides of Si, Al, Ti, W, Mo, Ni, Zn, Hf, Zr, V, Re, Sn, In, and Nb. Other particles can alternatively be used, provided they form a monolithic skeletal structure in the finished body. Such particles may be prepared by any appropriate means including, without limitation, processes that entail use of grinding, crushing, milling, or other mechanical comminution processes to make small particles from larger precursors, as well as direct routes such as chemical synthesis, gas-phase synthesis, condensed phase synthesis, high speed deposition by ionized cluster beams, consolidation, deposition and sol-gel methods. It is preferred that the ceramic particles have a zeta potential of at least about 10 mV. Use of particles having a zeta potential of at least 10, or 15, or 25 mV promotes the formation of a stable dispersion.

For example, suitable forms of colloidal silica are available from W. R. Grace under the tradename LUDOX®. In an embodiment, colloidal SiO₂ particles having a diameter characterized by d₅₀ of 10 to 100 nm or 10 to 75 nm are incorporated in the present porous body. In a further embodiment, the particles consist essentially of colloidal SiO₂ particles having negative surface charge.

The ceramic particles used in fabricating the present element typically have sizes (as measured in the largest dimension) ranging from 8 to 100 nm, and may be spherical or have any other shape. The particles may be relatively uniform in size, having a narrow distribution of sizes concentrated around an average size, or there may be a wider dispersion of different sized particles.

A number of techniques are known in the art for characterizing the size of small particles by either indirect or direct measurements.

Techniques based on either dynamic or static light scattering are widely used. By assuming a suitable model, various statistical characterizations of an ensemble of particles can be obtained from the scattering data. The d₅₀ or median particle size by volume derived from light scattering is commonly used to represent the approximate particle size. Other common statistically derived measures of particle size include d₁₀ and d₉₀. It is to be understood that 10 vol. % and 90 vol. % of the particles in the ensemble have a size less than d₁₀ and d₉₀, respectively. These values, taken either singly or in combination with the d₅₀ values, can provide additional characterization of a particle distribution, which is especially useful for a distribution that is not symmetrical, or is multimodal, or complex.

Particle size can also be characterized by other radiation-based, indirect techniques that provide ensemble averages and size distributions, such as small-angle x-ray and neutron scattering. However, it is known that broad or multimodal distributions and irregular shaped particles or distributions of shape complicate interpretation of the scattering data obtained using any of the foregoing techniques.

Direct imaging, e.g. using scanning or transmission electron microscopy, permits individual particles to be imaged and sized directly. Image analysis techniques can be applied to electron micrographs to quantify size distributions and shape characteristics, such as the departure from spherality. However, skilled interpretation is still needed to identify other crucial features, such as porosity, and to ascertain whether the object being visualized is a primary particle or an association of multiple primary particles, e.g. particles that have agglomerated or are joined more rigidly.

In various embodiments, the fabrication process is carried out using ceramic particles having an average size (as measured in the largest dimension) of 5 to 20 nm, or 18 to 23 nm, or 25 to 35 nm, or 10 to 50 nm, as measured by a d₅₀ value determined using static or dynamic light scattering.

Various embodiments of the present fabrication method permit the average pore size and the pore size distribution of the fired structure to be well controlled. The structure after firing is largely governed by the initial size of the ceramic particles and their volumetric loading, since the particles in large measure retain their sizes and the spatial relationships established in the green compact preform. Without being bound by any theory, it is believed that the open spaces after firing arise from three-dimensional volumes in the green compact originally filled by the matrix polymer. A smaller pore size in the fired element can ordinarily be obtained by decreasing the original ceramic particle size or increasing the loading in the green compact. In an embodiment, the average pore size in the present porous body ranges from about 5 to 50 nm, about 10 to 20 nm, about 4-8 nm, or about 12-16 nm. Other embodiments may exhibit a combination of a small pore size and a high porosity, such as any combination of: (i) an average pore size ranging from about 5 to 50 nm, about 10 to 20 nm, about 4 to 8 nm, or about 12 to 16 nm, and a porosity of at least about 30 vol. %, 50 vol. %, 60 vol. %, 70 vol. %, or 75 vol. %.

In an embodiment, the ceramic particle loading in the green compact is sufficient to establish percolation, so that a skeletal structure can be established during firing by the bonding of contiguous particles to one another, yielding a final porous body that has adequate strength and mechanical integrity. The upper limit on possible loading is ordinarily established by both processability and the density attainable with close packing. For example, the particle loading may be 30% to 70%, or 40% to 60% by volume in various embodiments. The breadth of the particle size distribution may affect the preferred loading.

In an embodiment, the ceramic particles for the present porous body are supplied from a colloidal suspension in a carrier solvent comprising water or other solvent. In various embodiments, the carrier solvent may be at least one of water or a polar organic solvent, including, without limitation, dimethylformamide (DMF), N,N-dimethylacetamide (DMAc), ethylene glycol, propylene glycol, a C1-C4 alcohol, or a mixture thereof. It is preferred that the carrier solvent be capable of supporting a charge-stabilized colloidal suspension of the desired ceramic particles, such as silica.

Suitable polymer matrix materials include, without limitation, polyethylene oxide, polypropylene oxide, polymethylmethacrylate, polystyrene, polyvinylchloride, polyethylene terephthalate, polyamide, polyamic acid, polyimide, polyoxymethylene, polycarbonate, chitosan, and cellulose.

The solvent used to prepare the dispersion combining the ceramic particles and the polymer matrix material may be the carrier solvent or another solvent, provided the respective solvents are compatible. It is preferred that the same solvent be used and capable of supporting both a charge-stabilized colloidal suspension of the desired ceramic particles, such as silica, and a dispersion or solution of the polymer matrix material. Embodiments wherein the solvent is capable of both functions are beneficial, since removal of the liquid by heating, evaporation, or a combination thereof, permits straightforward preparation of a dried powder in which the particles are well dispersed, and the subsequent formation of the dried powder into a green compact. A solvent that is at least predominantly water is especially preferred as being low-cost, environmentally benign, and fully removable by evaporation and/or heating without creating any residual material or contaminants.

In an embodiment, poly(methyl methacrylate) polymer (PMMA) and colloidal silica particles in DMF are used. The preform in another embodiment is formed with polyethylene oxide (PEO) and colloidal silica in water. Beneficially, polyethylene oxide is water soluble, facilitating the preparation of the intermediate powder and green compact.

Also provided is a method for manufacturing a nanoporous ceramic structure.

Similar techniques may also be used to prepare a supported porous body, comprising a substrate and a monolithic, porous layer bonded thereto. For example, such an embodiment might be used to provide strength or other mechanical properties beyond what could be attained in a monolithic, self-supporting porous body. The substrate in such an embodiment optionally is dense, meaning it is impervious to the passage of fluid. The substrate might also be an open structure, such as a wire mesh. Such a configuration might be used in a filtration system, the mesh providing a first level of filtering to remove large particles, and the porous body providing a second level of filtering thereafter to remove nanoscale particles.

In one implementation for manufacturing the supported porous body, the porous body portion is first prepared by any suitable method, including the method disclosed above, and thereafter bonded to the substrate. Alternatively, a green compact may be formed directly on the substrate and afterward firing the entire assembly. Of course, the substrate must be capable of withstanding the firing conditions. In some configurations, use of a supporting substrate permits formation of a porous body that by itself would be too thin to have sufficient structural integrity to make it simply manipulable.

A further aspect provides a filtration system employing the present porous body as part of a filter element. The filtration system is configured to receive fluid at an inlet and deliver the fluid at an outlet. The filter element is configured such that at least some, and preferably all, of the input fluid must pass through the porous body, thereby filtering the input fluid to produce a filtrate, from which at least a portion, and possibly substantially all, of any particulate material larger than a desired size is removed. The filtrate is then conveyed to the output.

In an implementation, the filter element comprises a fluidic connection that provides an input channel, such as a first tube or pipe, to convey fluid entering the inlet to an input side of the porous body and an output channel, such as a second tube or pipe, to convey filtrate from an output side of the porous body to the outlet.

The filtration system optionally comprises a pump or other like flow-inducement means that urges fluid entering the inlet to pass through the filter element and emerge at the outlet. In addition to a pump of any type that affords the requisite flow rate and pressure capability, the flow-inducement means can include gravity, a siphon system, a vacuum system, or other configuration that causes fluid flow.

The filtration system can be either open-loop or closed-loop, meaning that a fluid volume element from a source can either pass through the system once and thereafter exit after being filtered; or be recirculated and be filtered repetitively through the filter element.

For example, a fluid appointed for infusion into a human for medical treatment might be produced initially, then filtered by a single passage through the present filtration system, and then packaged to be ready for administration.

On the other hand, a fluid used as a heat transfer medium in an apparatus might be recirculated, but passed during each circuit through the filtration system to remove any contaminants packed up during operation. Ordinarily, fluid in a closed-loop filtration system is filtered and emerges from the system outlet, then passes through additional process apparatus, and is then returned to the system inlet for removal of particulate material picked up during passage through the process apparatus.

The filtration may be accomplished using porous bodies having any appropriate shape. For example, a plate or disk having a thickness that is much less than the size in the two orthogonal dimensions (e.g., a thickness at least ten times smaller than a length, width, or diameter) may be used. In an embodiment, the porous body has sufficient thickness to render it self-supporting. Such a porous body might have a thickness of at least 100 μm, 500 μm, or 1 mm. In another representative implementation, the filter element is configured as a cylindrical shell having inner and outer cylindrical surfaces. Input fluid may be introduced into the interior of the shell and flow generally radially outward through the shell and emerge after filtration at the outer cylindrical surface. Such a cylindrical shell may have a thickness (as measured in a radial direction) of at least 100 μm, 500 μm, or 1 mm. Of course, other filter element geometrical configurations and dimensions will be apparent to a skilled person and are contemplated herein.

In a still further aspect, the foregoing filtration system is used in the practice of a method of filtering a fluid containing particles to produce a filtrate, from which at least a portion of any particulate material larger than a desired size is removed.

### EXAMPLES

The operation and effects of certain embodiments of the present invention may be more fully appreciated from a series of examples, as described below. The embodiments on which these examples are based are representative only, and the selection of those embodiments to illustrate aspects of the invention does not indicate that materials, components, reactants, conditions, techniques and/or configurations not described in the examples are not suitable for use herein, or that subject matter not described in the examples is excluded from the scope of the appended claims and equivalents thereof.

### Materials

Materials used in carrying out the examples and comparative examples set forth below include the following:

### Polymers:

Poly(methyl methacrylate) (PMMA), obtained from Aldrich and having a molecular weight (Mw) determined by size-exclusion chromatography to be about 93,000;
Poly(methyl methacrylate) (PMMA), obtained from Aldrich and having a listed molecular weight (Mw) of 120,000;
Poly(methyl methacrylate) (PMMA), obtained from Aldrich and having a listed molecular weight (Mw) of 600,000;
Polyethylene oxide (PEO), obtained from Scientific Polymer Products, Inc., and having a listed molecular weight (Mw) of 100,000.

### Filler:

Colloidal silica (CS) in water, obtained as Ludox® AS-40 from W. R. Grace, and having an average particle diameter of 28 nm and a polydispersity of 0.11;
Colloidal silica (CS) in DMAc, obtained as DMAC-ST from Nissan Chemical, and having an effective particle diameter of 8.9 nm and a polydispersity of 0.40, as determined by dynamic light scattering;
Colloidal silica (CS) in DMF, obtained by adding Ludox® AS-40 in water to DMF, and boiling off the water to produce a DMF dispersion having an average particle diameter of 28 nm and a polydispersity of 0.11;
Colloidal silica (CS) in water, obtained as SIS 6963.4 from Gelest, and having an average particle diameter of 22 nm and a polydispersity of 0.29.

### Example 1

### Preparation of a Porous Body Based on a PMMA Nanocomposite with 50 Vol. % Colloidal Silica

A porous body was fabricated from a pressed disk sample of poly(methyl methacrylate) with 50 vol. % colloidal silica.

First, a dispersion of colloidal silica (CS) in dimethylformamide (DMF) was prepared by adding a Ludox® AS-40 aqueous dispersion to DMF and boiling the water away to provide a 21.2 wt. % dispersion in DMF. Then the CS-DMF dispersion was combined with a solution of PMMA (93K Mw), vortex-mixed for 1 min, and then mixed overnight in a jar mill (US Stoneware, Mahwah, N.J.). The mixed formulation was coated onto a clean glass plate (17×17 cm) with a 0.25 mm doctor blade (Gardner Corp, Florida), and dried in a nitrogen-purged oven at 150° C. and vacuum (20 inches Hg≅68 kPa) overnight. The dried coating was scraped from the glass. The density of the resulting material was determined using He pycnometery (Accupyc 1330, Micromeritics, Norcross, Ga.) to be 1.4525 gm/cm³.

A 1 mm thick disk-shaped sample of the CS/PMMA composite was prepared by a vacuum hot-pressing technique. A 0.194 g charge of the foregoing dried coating material was placed in a pellet press equipped with a polished steel die set (1 cm diameter) and a shroud. A thermocouple was placed for measurement of the sample temperature. The die assembly was encased with a polyethylene wrap and pumped for 10 min at room temperature. The pellet press was evacuated through a side port and placed in a Carver press (Carver, Wabash, Ind.). Vacuum was applied for an additional 10 min with 200 pounds (890 N) of force being applied. Then the force on the press was raised to 2000 (8900 N) pounds with the temperature raised to a set point of 180° C. over a 30 min period, which resulted in a sample temperature that varied between about 160° C. and 166° C. After a 10 min dwell time, pressure was released and the equipment allowed to cool to ambient temperature. The polymer nanocomposite was carefully extracted and found, apart from some minor artifacts, to be transparent and free of bubbles. The sample had sufficient strength and mechanical integrity to permit it to be manipulated without difficulty. Using the Archimedean method, the density of the compact was found to be 1.3748 g/cm³.

The resulting CS/PMMA composite disk sample (1 cm diameter and about 1 mm thick) was then ashed to produce a porous body. The disk was placed into an ashing furnace (Barnstead 6000, Dubuque, Iowa), which was ramped to 350° C. and held for 4 h in air. This step decomposed the polymer, leaving a cohesive, self-supporting article of CS. Measurements taken using a Micromeritics ASAP 2405 Accelerated Surface Area and Porosimetry System (Norcross, Ga.) provided a surface area of 108.3 m²/g by the Brunauer-Emmett-Teller (BET) technique, a modal pore diameter of 13.4 nm by the Barrett-Joyner-Halenda (BJH) desorption method, and a total porosity of 49 vol. %. The sample's density was measured by He pycnometry to be 2.316 g/cm³. FIG. 1 provides a plot depicting the pore size distribution of the porous body of Example 1.

### Example 2

### Preparation of a Porous Body Based on a PMMA Nanocomposite with 70 Vol. % Colloidal Silica

Using techniques generally similar to those employed for Example 1, a porous body was fabricated from a pressed disk sample of PMMA with 70 volume percent colloidal silica. Dried material was obtained from a formulation of 20.6 wt. % DMAC-ST colloidal silica with a 12.2 wt. % solution of 120K MW PMMA in DMAc.

The material was compression-molded using the same apparatus. After the same initial pump-down, the sample was placed under vacuum, held at room temperature with an applied force of 400-500 pounds (1800-2200 N), then ramped under vacuum to a set point of 176° C. and held under pressure for 30 min, then cooled to room temperature and held overnight.

The polymer nanocomposite was then fired by ramping it to 350° C. and holding for 4 h to remove the polymer and create the porous body.

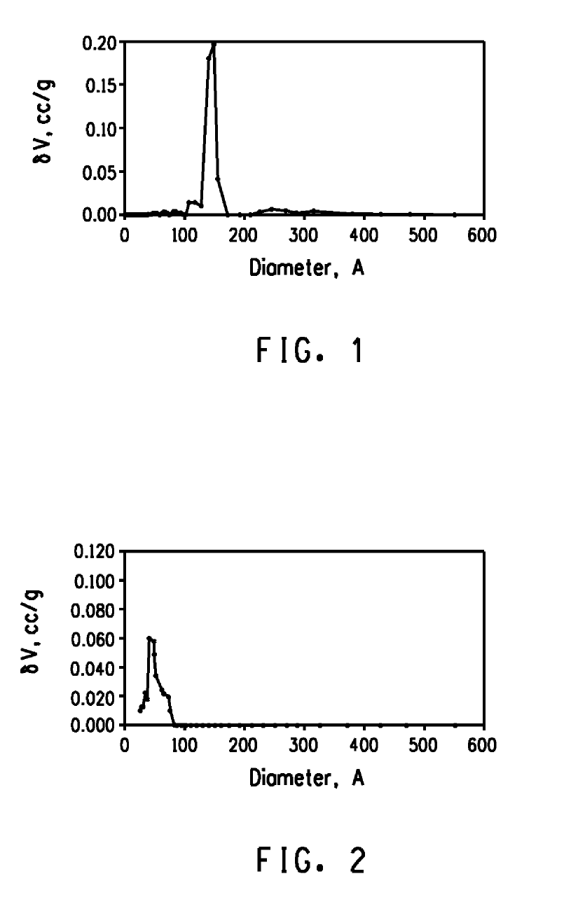

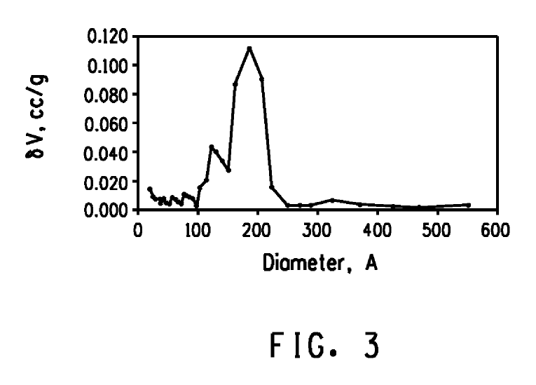

After cooling, the porous body was characterized by the same techniques and apparatus used for Example 1. It was found to have a BET surface area of 210.5 m²/g, a total porosity of 30%, and a modal pore diameter of 5.8 nm, with a pore size distribution as depicted by FIG. 2.

### Example 3

### Preparation of a Porous Body Based on a PMMA Nanocomposite with 30 Vol. % Colloidal Silica

Using techniques generally similar to those employed for Examples 1 and 2, a porous body was fabricated from a pressed disk sample of PMMA with 30 vol. % colloidal silica. Dried material was obtained from a formulation of 21.2 wt % DMAC-ST colloidal silica with a 11.7 wt % solution of 600K MW in PMMA DMAc. This formulation was processed in accord with Examples 1 and 2, first to form the dried material and then to form a polymeric nanocomposite that was fired to produce a porous body. Again using the techniques and apparatus discussed in Example 1, the BET surface area was measured as 211 m²/g, the total porosity was 63%, and the modal pore diameter was 19.0 nm, with a pore size distribution as depicted by FIG. 3.

### Example 4

### Preparation of a Porous Body Based on a PMMA Nanocomposite with 60 Vol. % Colloidal Silica

Using techniques generally similar to those employed for Examples 1-3, a porous body was fabricated from a pressed disk sample of PMMA with 60 vol. % colloidal silica. Dried material was obtained from a formulation of 21.2 wt % DMAC-ST colloidal silica with a 11.7 wt % solution of 600K MW in PMMA DMAc. This formulation was processed in accord with Examples 1-3, first to form the dried material and then to form a polymeric nanocomposite that was fired to produce a porous body. The resulting BET surface area was 115.4 m²/g, the total porosity was 41%, and the modal pore diameter was 14.0 nm, as determined using the Micromeritics ASAP 2405 System.

### Example 5

### Preparation of a Porous Body Based on a PEO Nanocomposite with 55 Vol. % Colloidal Silica

Using techniques generally similar to those employed for Examples 1-4, a porous body was fabricated from a pressed disk sample of polyethylene oxide with 55 vol. % colloidal silica. Dried material was obtained from a formulation of 21.0 wt. % of colloidal silica in a water dispersion with a 10.0 wt. % solution of 100K MW PEO in water. This formulation was processed in accord with Examples 1-4, first to form the dried material and then to form a polymeric nanocomposite that was fired to produce a porous body. The resulting BET surface area was 129 m²/g, the total porosity was 44%, and the modal pore diameter was 13.8 nm, as determined using the Micromeritics ASAP 2405 System.

It was found that the porous bodies produced in Examples 1-5 were all self-supporting, with nanometer-scale pores and relatively high porosity, rendering them suitable for filtration applications appointed for filtering nanoscale particles from a fluid.

Having thus described the invention in rather full detail, it will be understood that such detail need not be strictly adhered to, but that additional changes and modifications may suggest themselves to one skilled in the art. Other methods and materials similar or equivalent to those described herein can be used in the practice or testing of the invention. For example, additional additives known for use as processing aids or to enhance properties may be added at various stages of producing the present composite body. It is to be understood that the present manufacturing process may be implemented in various ways, using different equipment and carrying out the steps described herein in different orders. All of these changes and modifications are to be understood as falling within the scope of the invention as defined by the subjoined claims.

In addition to vendors named elsewhere herein, various materials suitable for use herein may be made by processes known in the art, and/or are available commercially from a variety of suppliers.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. In addition, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

Each of the formulae shown herein describes each and all of the separate, individual compounds or monomers that can be assembled in that formula by (1) selection from within the prescribed range for one of the variable radicals, substituents or numerical coefficents while all of the other variable radicals, substituents or numerical coefficents are held constant, and (2) performing in turn the same selection from within the prescribed range for each of the other variable radicals, substituents or numerical coefficents with the others being held constant. In addition to a selection made within the prescribed range for any of the variable radicals, substituents or numerical coefficents of only one of the members of the group described by the range, a plurality of compounds or monomers may be described by selecting more than one but less than all of the members of the whole group of radicals, substituents or numerical coefficents. When the selection made within the prescribed range for any of the variable radicals, substituents or numerical coefficents is a subgroup containing (i) only one of the members of the whole group described by the range, or (ii) more than one but less than all of the members of the whole group, the selected member(s) are selected by omitting those member(s) of the whole group that are not selected to form the subgroup. The compound, monomer, or plurality of compounds or monomers, may in such event be characterized by a definition of one or more of the variable radicals, substituents or numerical coefficents that refers to the whole group of the prescribed range for that variable but where the member(s) omitted to form the subgroup are absent from the whole group.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

What is claimed is:

1. As an article of manufacture, a porous body having an outer surface that defines a shape having a bulk volume, the porous body consisting essentially of a plurality of ceramic particles having an average size ranging from 8 to 100 nm, and wherein:
a) the ceramic particles are bonded to adjacent ceramic particles with a strength sufficient to render the porous body self-supporting;
b) the porous body has a porosity ranging from 30 to 70 vol. %; and
c) the porous body has an average pore size ranging from about 5 to 50 nm.

2. The porous body of claim 1, wherein the shape is a plate or disk having a thickness of at least 100 μm.

3. The porous body of claim 1, wherein the ceramic particles are colloidal silica particles.

4. The porous body of claim 1, wherein the ceramic particles have a zeta potential of at least 10 mV.

5. The porous body of claim 1, having a porosity of 40 to 60%.

6. The porous body of claim 1, wherein the average pore size ranges from about 10 to 20 nm.

7. The porous body of claim 1, wherein the average pore size ranges from about 10 to 20 nm and the porosity ranges from 40 to 60%.

8. A method for manufacturing a porous body having an outer surface that defines a shape having a bulk volume, comprising:
a) producing a polymeric nanocomposite comprising a plurality of ceramic particles having an average size ranging from 8 to 100 nm dispersed in a polymeric matrix material, the ceramic particles comprising 30 to 70% of the bulk volume of the polymeric nanocomposite; and
b) firing the polymeric nanocomposite at a firing temperature and for a firing time sufficient to remove substantially all the polymeric matrix material and to cause the ceramic particles to become bonded to adjacent ceramic particles with a strength sufficient to render the porous body self-supporting.

9. The method of claim 8, wherein the ceramic particles are colloidal silica.

10. The method of claim 8, wherein the polymeric matrix comprises at least one of polyethylene oxide, polypropylene oxide, polymethylmethacrylate, polystyrene, polyvinylchloride, polyethylene terephthalate, polyamide, polyamic acid, polyimide, polyoxymethylene, polycarbonate, chitosan, or cellulose,

11. The method of claim 8, wherein the polymeric matrix consists essentially of polyethylene oxide.

12. The method of claim 8, wherein the firing temperature is below a sintering temperature of the ceramic material.

13. The method of claim 12, wherein the firing temperature is at least 100° C. and less than 1000° C.

14. The method of claim 8, wherein the production of the polymeric nanocomposite comprises:
a) dispersing the ceramic particles and the polymeric matrix material in a solvent;
b) removing the solvent to form a dispersed powder;
c) forming the dispersed powder into a compact shape.

15. The method of claim 14, wherein the solvent comprises water.

16. The method of claim 14, wherein the solvent comprises a polar organic liquid.

17. The method of claim 14, wherein the polar organic liquid comprises at least one of dimethylformamide, N,N-dimethylacetamide, ethylene glycol, or a C1-C4 alcohol.

18. The method of claim 14, wherein the ceramic particles are supplied as a charge-stabilized, colloidal dispersion in a carrier solvent.

19. The method of claim 14, wherein the forming comprises die pressing.

20. A method for filtering a fluid containing particulate material to produce a filtrate, comprising:
(a) providing a filter element comprising the porous body recited by claim 1; and
(b) passing the fluid through the filter element, whereby the fluid is filtered to remove at least a portion of the particulate material to produce the filtrate.

21. A filtration system configured to filter a fluid containing particulate material to produce a filtrate, and comprising a filter element having an input and an output, and wherein:
(a) the filter element comprises the porous body of claim 1;
(b) the input is in fluidic communication with the porous body, such that fluid received at the input is delivered to the porous body for passage therethrough to produce filtrate; and
(c) the output is in fluidic communication with the porous body, such that filtrate emerging from the porous body is delivered to the output.

22. As an article of manufacture, a supported porous body, comprising a substrate and a monolithic, porous layer supportedly bonded thereto, the porous layer consisting essentially of a plurality of ceramic particles having an average size ranging from 8 to 100 nm, and wherein:
a) the ceramic particles are bonded to adjacent ceramic particles with a strength sufficient to provide the supported porous body with structural integrity;
b) the porous body has a porosity ranging from 30 to 70 vol. %; and
c) the porous body has an average pore size ranging from about 5 to 50 nm.
